(19) United States
(12) Patent Application Publication
(10) Pub. No.: US 2017/0193358 A1
(43) Pub. Date: Jul. 6, 2017

(54) NEUROMORPHIC DEVICES INCLUDING POST-SYNAPTIC NEURONS HAVING AT LEAST ONE OF INTEGRATORS, AMPLIFIERS, OR SAMPLING ELEMENTS

(71) Applicant: SK hynix Inc., Icheon (KR)

(72) Inventor: Hyung-Dong LEE, Icheon (KR)

(21) Appl. No.: 15/391,761

(22) Filed: Dec. 27, 2016

Related U.S. Application Data
(60) Provisional application No. 62/273,278, filed on Dec. 30, 2015.

(30) Foreign Application Priority Data
Aug. 18, 2016 (KR) 10-2016-0104947

(51) Int. Cl. G06N 3/063; G06N 3/04

(52) U.S. Cl. CPC G06N 3/0635; G06N 3/04

(57) ABSTRACT

A neuromorphic device may include: a pre-synaptic neuron; a row line electrically coupled to the pre-synaptic neuron; a post-synaptic neuron; a column line electrically coupled to the post-synaptic neuron; and a synapse disposed at a cross point between the row line and the column line. The post-synaptic neuron may include: a first integrator electrically coupled to the synapse; a second integrator electrically coupled to the first integrator; and a comparator electrically coupled to the second integrator.

### CROSS-REFERENCE TO RELATED APPLICATIONS

The present application claims priorities of U.S. Patent Provisional Application No. 62/273,278, filed to the U.S. Patent and Trademark Office on Dec. 30, 2015, and Korean Patent Application No. 10-2016-0104947 filed to Korean Intellectual Property Office on Aug. 18, 2016 which are incorporated herein by reference in their entirety.

### BACKGROUND

1. Field

Exemplary embodiments of the present disclosure relate to neuromorphic devices, and more particularly, to neuromorphic devices including post-synaptic neurons each of which includes at least one of a plurality of integrators, amplifiers, or sampling elements.

2. Description of the Related Art

Neuromorphic technology to mimic human brain is spotlighted recently. A neuromorphic device based on the neuromorphic technology includes a plurality of pre-synaptic neurons, a plurality of post-synaptic neurons, and a plurality of synapses. Such a neuromorphic device may output pulses or spikes having diverse levels, intensities, or times according to learning states.

Synapses of a neuromorphic device may learn diverse data patterns. In a reading mode, synapses that have learned similar data patterns may output similar data signals. Therefore, a data recognition error may occur.

### SUMMARY

Embodiments of the present disclosure are directed to a neuromorphic device that may substantially prevent or minimize an occurrence of data recognition errors.

The beneficial aspects of the present disclosure are not limited to the above-mentioned beneficial aspect, and other beneficial aspects may be possible.

In accordance with an embodiment of the inventive concepts, a neuromorphic device may include a pre-synaptic neuron; a row line electrically coupled to the pre-synaptic neuron; a post-synaptic neuron; a column line electrically coupled to the post-synaptic neuron; and a synapse disposed at a cross point between the row line and the column line. The post-synaptic neuron may include: a first integrator electrically coupled to the synapse; a second integrator electrically coupled to the first integrator; and a comparator electrically coupled to the second integrator.

The synapse and an input terminal of the first integrator may be electrically connected to each other.

An output terminal of the first integrator and an input terminal of the second integrator may be electrically connected to each other.

An output terminal of the second integrator and an input terminal of the comparator may be electrically connected to each other.

The first integrator, the second integrator, and the comparator may be electrically connected in series.

The post-synaptic neuron may further include: a first amplifier disposed between an output terminal of the first integrator and an input terminal of the second integrator.

The post-synaptic neuron may further include: a second amplifier disposed between an output terminal of the second integrator and an input terminal of the comparator.

The post-synaptic neuron may further include: a sampling element disposed between the synapse and the first integrator.

The sampling element may include a switching element.

The post-synaptic neuron may further include: an amplifier disposed between the sampling element and the first integrator.

The first integrator and the second integrator may be leaky integrators.

The post-synaptic neuron may be a first post-synaptic neuron. The synapse may be a first synapse. The comparator may be a first comparator. The neuromorphic device may further include a second post-synaptic neuron coupled to a second synapse, the first synapse and the second synapse being coupled to the row line. The first post-synaptic neuron may further include: a third integrator serially connected between the second integrator and the first comparator. The second post-synaptic neuron may include: a fourth integrator electrically connected to the second synapse; a fifth integrator electrically connected to the fourth integrator; a sixth integrator electrically connected to the fifth integrator; and a second comparator electrically connected to the sixth integrator.

In accordance with an embodiment of the inventive concepts, a neuromorphic device may include: a pre-synaptic neuron; a synapse electrically coupled to the pre-synaptic neuron; and a post-synaptic neuron electrically coupled to the synapse. The post-synaptic neuron may include: at least two integrators coupled in series to each other; and a comparator coupled to the at least two integrators.

The post-synaptic neuron may further include: one or more amplifiers each disposed between two adjacent integrators among the at least two integrators.

The post-synaptic neuron may further include: an amplifier disposed between a last one of the at least two integrators and the comparator, the last one of the at least two integrators being a farthest integrator from the synapse.

The post-synaptic neuron may further include: an amplifier disposed between the synapse and a first one of the at least two integrators, the first one of the at least two integrators being a closest integrator to the synapse.

The post-synaptic neuron may further include: a sampling element disposed between the synapse and a first one of the at least two integrators, the first one of the at least two integrators being a closest integrator to the synapse.

In accordance with an embodiment of the inventive concepts, a neuromorphic device may include: a pre-synaptic neuron; a synapse electrically coupled to the pre-synaptic neuron, the synapse generating a data signal according to a data pattern in a reading mode; and a post-synaptic neuron electrically coupled to the synapse. The post-synaptic neuron may include: a first integrator coupled to the synapse, the first integrator performing a first integration operation on the data signal to generate a first integrated version of the data signal; a second integrator coupled to the first integrator, the second integrator performing a second integration operation on the first integrated version of the data signal to generate a second integrated version of the data signal; and a comparator coupled to the second integrator, the comparator comparing the second integrated version of the data signal to a reference signal.

The post-synaptic neuron may further include an amplifier disposed between the first integrator and the second integrator, the amplifier amplifying the first integrated version of the data signal and outputting the amplified signal to the second integrator.

The post-synaptic neuron may further include a switching element disposed between the synapse and the first integrator, the switching element coupling the synapse and the first integrator in response to a switching control signal.

### BRIEF DESCRIPTION OF THE DRAWINGS

FIG. 1 is a block diagram conceptually illustrating a neuromorphic device in accordance with an embodiment of the present disclosure.

FIG. 2 is a block diagram conceptually illustrating a portion of a neuromorphic device in accordance with an embodiment of the present disclosure.

FIGS. 3A to 3C are graphs showing a process of reading a first data pattern in the neuromorphic device of FIG. 2 in accordance with an embodiment.

FIG. 4 is a block diagram conceptually illustrating a portion of a neuromorphic device in accordance with an embodiment of the present disclosure.

FIGS. 5A to 5C are graphs showing a process of reading a first data pattern in the neuromorphic device of FIG. 4 in accordance with an embodiment.

FIG. 6 is a block diagram conceptually illustrating a portion of a neuromorphic device in accordance with an embodiment of the present disclosure.

FIGS. 7A to 7C are graphs showing a process of reading a first data pattern in the neuromorphic device of FIG. 6 in accordance with an embodiment shown in FIG. 6.

FIGS. 8 to 11 are block diagrams conceptually illustrating portions of neuromorphic devices in accordance with various embodiments of the present disclosure.

FIG. 12 is a block diagram conceptually illustrating a pattern recognition system in accordance with an embodiment of the present disclosure.

### DETAILED DESCRIPTION

Exemplary embodiments of the inventive concepts will be described below in more detail with reference to the accompanying drawings. The inventive concepts may, however, be embodied in different forms and should not be construed as limited to the embodiments set forth herein. Rather, these embodiments are provided to make this disclosure thorough and complete, and fully convey the scope of the inventive concepts to those skilled in the art. The spirit and scope of the invention are as defined in the claims.

The terms used in this patent specification are for describing the embodiments of the inventive concepts and they do not limit the scope of the inventive concepts. In this specification, the use of a singular term includes a plural term as well unless mentioned otherwise. The use of an expression “comprises” and/or “comprising” a constituent element, step, and/or device in this patent specification does not exclude the presence or addition of another constituent element, step, and/or device.

When an element is described in this specification to be “connected to” or “coupled to” another element, the description includes not only a direct connection or coupling but also an indirect connection or coupling where yet another element is interposed between them. On the other hand, when an element is described to be “directly connected to” or “directly coupled to” another element, the description means that there are no other elements interposed between them. The expression “and/or” means each of the mentioned items, and all combinations of one or more of the mentioned items.

Throughout the disclosure, like reference numerals refer to like parts throughout the various figures and embodiments of the inventive concepts. Therefore, the reference numerals may be referred to and described, although they are not mentioned and/or described in the corresponding drawing. Also, even though a reference numeral does not appear in the corresponding drawing, the constituent element of the reference numeral may be described by referring to other drawings.

In this specification, ‘potentiation’, ‘set’, ‘training’, and ‘learning’ may be used as the same or similar terms, and ‘depressing’, ‘reset’, and ‘initiation’ may be used as the same or similar terms. For example, an operation of lowering resistance values of synapses may be exemplified as potentiation, setting, or learning, and an operation of raising the resistance values of synapses may be exemplified as depressing, resetting, or initiation. Furthermore, when a synapse is potentiated, set, trained, or learned, a gradually increasing voltage/current may be outputted from the synapse because the conductivity of the synapse is increased. When a synapse is depressed, reset, or initiated, a gradually decreasing voltage/current may be outputted from the synapse because the conductivity of the synapse is decreased. For convenience of description, a data pattern, an electrical signal, a pulse, a spike, and a fire may be interpreted as having the same, similar, or compatible meaning. Furthermore, a voltage and a current may also be interpreted as having the same or compatible meaning.

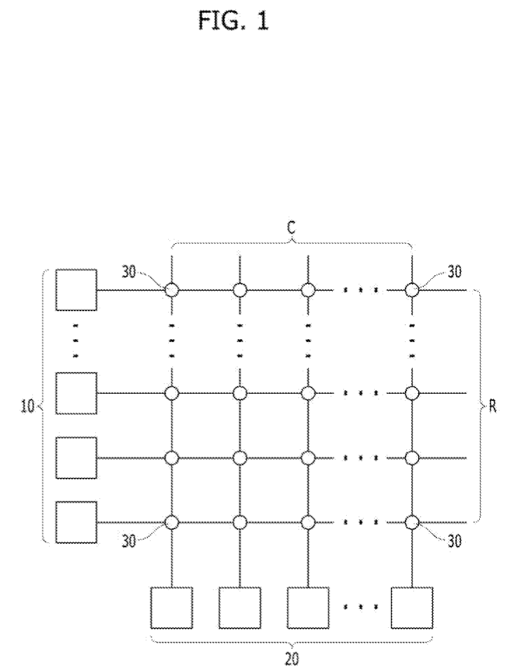

FIG. 1 is a block diagram conceptually illustrating a neuromorphic device in accordance with an embodiment of the present disclosure. Referring to FIG. 1, the neuromorphic device in accordance with the embodiment may include a plurality of pre-synaptic neurons 10, a plurality of post-synaptic neurons 20, a plurality of synapses 30, a plurality of row lines R, and a plurality of column lines C.

The pre-synaptic neurons 10 may transmit electrical signals to the synapses 30 through the row lines R in a learning mode, a reset mode, or a reading mode.

The post-synaptic neurons 20 may transmit electrical signals to the synapses 30 through the column lines C in the learning mode or the reset mode, and receive electrical signals from the synapses 30 through the column lines C in the reading mode.

Each of the synapses 30 may include a bipolar element such as a variable resistive device. For example, the bi-polar element may include a first electrode that is electrically connected to a corresponding one of the pre-synaptic neurons 10 and a second electrode that is electrically connected to a corresponding one of the post-synaptic neurons 20. The synapses 30 may have multiple resistance levels. The variable resistive device of the synapse 30 may include at least one selected from a group including a metal oxide such as a transition metal oxide and a perovskite-based material, a phase-change material such as a chalcogenide-based material, a ferroelectric material, and a ferromagnetic material. The synapses 30 may be gradually changed between a high-resistance state and a low-resistance state according to the number of times of applying electrical signals, an inputting time difference between the electrical signals, and/or a voltage difference between the electrical signals, the electrical signals being input from the pre-synaptic neurons 10 and/or the post-synaptic neurons 20.

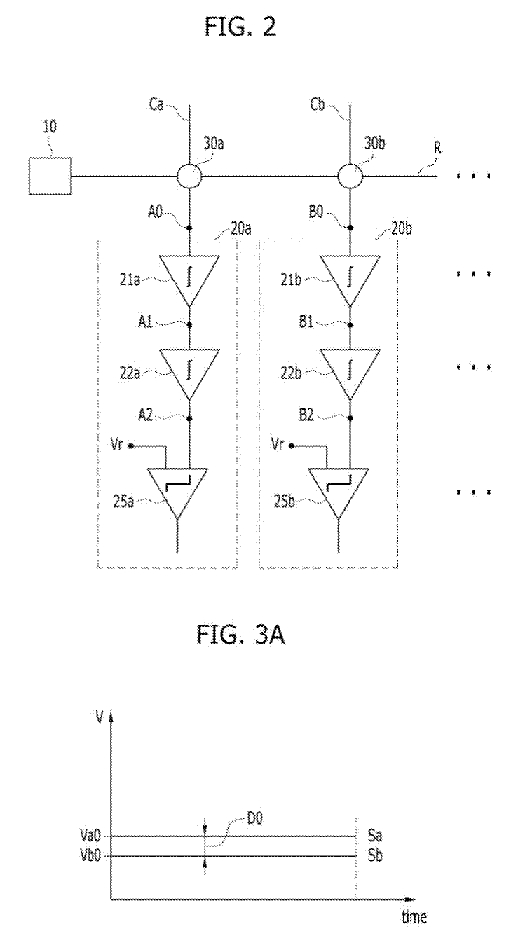

FIG. 2 is a block diagram conceptually illustrating a portion of a neuromorphic device in accordance with an embodiment of the present disclosure. For the sake of convenience in description, FIG. 2 shows the neuromorphic device that includes one pre-synaptic neuron 10, one row line R, first and second column lines Ca and Cb, first and second synapses 30a and 30b, and first and second post-synaptic neurons 20a and 20b.

Each of the first and second post-synaptic neurons 20a and 20b of the neuromorphic device may include at least two integrators and one comparator. The first and second post-synaptic neurons 20a and 20b may include first and second primary integrators 21a and 21b whose input terminals are electrically connected to the first and second synapses 30a and 30b through the first and second column lines Ca and Cb, respectively. The first and second post-synaptic neurons 20a and 20b may further include first and second secondary integrators 22a and 22b whose input terminals are electrically connected to output terminals of the first and second primary integrators 21a and 21b, respectively. The first and second post-synaptic neurons 20a and 20b may still further include first and second comparators 25a and 25b whose first input terminals are electrically connected to output terminals of the first and second secondary integrators 22a and 22b, respectively. In an embodiment, the first and second primary integrators 21a and 21b and the first and second secondary integrators 22a and 22b may be leaky integrators. Second input terminals of the first and second comparators 25a and 25b may receive a reference voltage Vr.

Hereinafter, a process of recognizing data patterns of the first and second synapses 30a and 30b in a reading mode is conceptually described. It is assumed herein that the first synapse 30a has already learned a first data pattern and the second synapse 30b has already learned a second data pattern.

To recognize the first data pattern that has been learned by the first synapse 30a, a first data read signal may be input from the pre-synaptic neuron 10 to the first and second synapses 30a and 30b through the row line R. Among the first and second synapses 30a and 30b that receive the first data read signal, a first data signal may be output from the first synapse 30a, which has learned the first data pattern, to the first post-synaptic neuron 20a. The first post-synaptic neuron 20a may be fired using the first primary integrator 21a, the first secondary integrator 22a, and the first comparator 25a. In other words, an electrical signal corresponding to the first data pattern may be output from the first post-synaptic neuron 20a.

When the second data pattern that has been learned by the second synapse 30b is similar to the first data pattern, a second data signal may be output from the second synapse 30b in response to the first data read signal. The second data signal may have a voltage or a current that is similar to that of the first data signal. When a first electrical signal corresponding to the first data signal and a second electrical signal corresponding to the second data signal are output from the first post-synaptic neuron 20a and the second post-synaptic neuron 20b, respectively, at proximate times, a data recognition error may occur. In short, the first and second post-synaptic neurons 20a and 20b may be fired almost at the same time. According to the embodiment of the present disclosure, however, a voltage difference between the first data signal and the second data signal may be amplified in the post-synaptic neurons 20a and 20b. For example, the first data signal is amplified in the first post-synaptic neuron 20a at a rate higher than a rate at which the second data signal is amplified in the second post-synaptic neuron 20b. Therefore, when the first post-synaptic neuron 20a is fired, the second post-synaptic neuron 20b may not be fired. In short, the first data pattern alone may be output from the first post-synaptic neuron 20a and recognized.

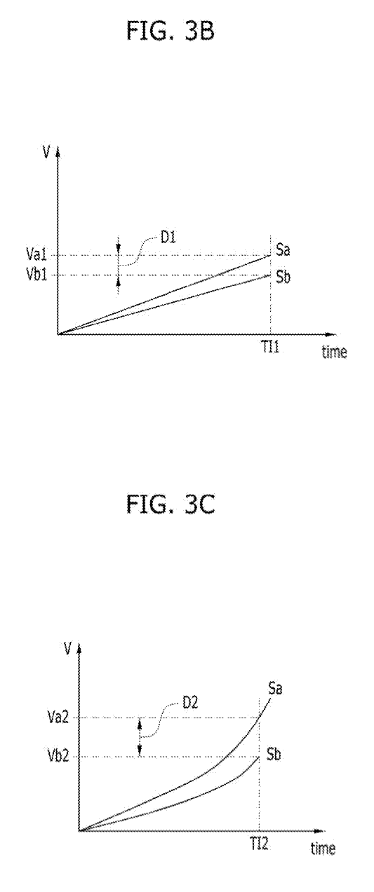

The concept and spirit of the inventive concepts will be described in detail by referring to FIGS. 3A to 3C. FIGS. 3A to 3C are graphs showing a process of reading the first data pattern in the neuromorphic device of FIG. 2 in accordance with an embodiment.

Referring to FIGS. 2 and 3A, in a reading mode, when the first data read signal is input from the pre-synaptic neuron 10 to the first and second synapses 30a and 30b through the row line R in order to read the first data pattern that has been learned by the first synapse 30a, a first data signal Sa and a second data signal Sb may be output from the first and second synapses 30a and 30b to input terminals of the first and second post-synaptic neurons 20a and 20b, e.g., the input terminals of the first and second primary integrators 21a and 21b, respectively.

When a resistance value of the first synapse 30a which has learned the first data pattern is lower than a resistance value of the second synapse 30b which has learned the second data pattern, a voltage level Va0 of the first data signal Sa that was measured at a first node A0 may be higher than a voltage level Vb0 of the second data signal Sb that was measured at a second node B0. The voltage level Va0 of the first data signal Sa that was measured at the first node A0 and the voltage level Vb0 of the second data signal Sb that was measured at the second node B0 may have a basic potential difference D0. If the first data pattern and the second data pattern are similar to each other, the basic potential difference D0 may be small enough to cause a data recognition error.

Referring to FIGS. 2 and 3B, a voltage level (or a first integrated version) Va1 of the first data signal Sa that was measured at a third node A1 after passing through the first primary integrator 21a and a voltage level Vb1 of the second data signal Sb that was measured at a fourth node B1 after passing through the second primary integrator 21b may be increased from zero volt, respectively, during a time interval TI1. As a result, at the end of the time interval TI1, a difference between the voltage level Va1 at the third node A1 and the voltage level Vb1 at the fourth node B1 increases to a first potential difference D1. The first potential difference D1 may be substantially equal to the basic potential difference D0.

Referring to FIGS. 2 and 3C, a voltage level (or a second integrated version) Va2 of the first data signal Sa that was measured at a fifth node A2 after passing through the first secondary integrator 22a and a voltage level Vb2 of the second data signal Sb that was measured at a sixth node B2 after passing through the second secondary integrator 22b may be non-linearly increased from zero volt, respectively, during a time interval TI2. As a result, at the end of the time interval TI2, a difference between the voltage level Va2 at the fifth node A2 and the voltage level Vb1 at the sixth node B2 increases to a second potential difference D2. The second potential difference D2 may be greater than the first potential difference D1. Specifically, the potential difference between the first data signal Sa and the second data signal Sb may be increased while passing through the first and second secondary integrators 22a and 22b, respectively.

Assuming that the voltage level Va2 of the first data signal Sa at the fifth node A2 becomes the same as or higher than a level of the reference voltage Vr before the voltage level Vb2 of the second data signal Sb at the sixth node B2 becomes as such, the first comparator 25a of the first post-synaptic neuron 20a may output an electrical signal earlier than the second comparator 25b of the second post-synaptic neuron 20b does. In short, the first post-synaptic neuron 20a may be fired first. The second comparator 25b of the second post-synaptic neuron 20b may be disabled when the first post-synaptic neuron 20a is fired. Thus, no electrical signal may be output from the second post-synaptic neuron 20b. Consequently, an occurrence of a data recognition error may be reduced in accordance with the embodiment of the present disclosure.

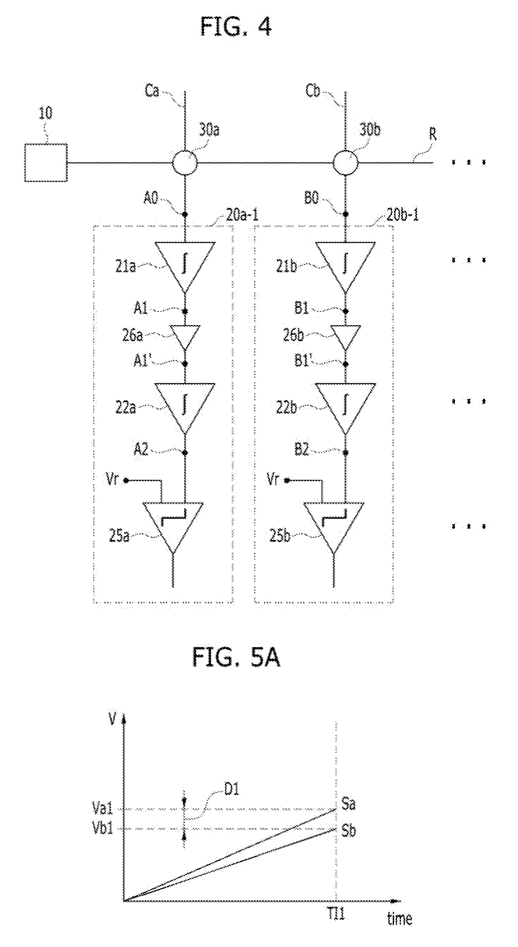

FIG. 4 is a block diagram conceptually illustrating a portion of a neuromorphic device, particularly, first and second post-synaptic neurons 20a-1 and 20b-1, in accordance with an embodiment of the present disclosure. Referring to FIG. 4, the first and second post-synaptic neurons 20a-1 and 20b-2 of the neuromorphic device in accordance with the embodiment may include first and second amplifiers 26a and 26b that are disposed between the primary integrators 21a and 21b and the secondary integrators 22a and 22b, respectively, in addition to the constituent elements of the first and second post-synaptic neurons 20a and 20b illustrated in FIG. 2. Input terminals of the first and second amplifiers 26a and 26b may be electrically connected to output terminals of the first and second primary integrators 21a and 21b, respectively, and output terminals of the first and second amplifiers 26a and 26b may be electrically connected to input terminals of the first and second secondary integrators 22a and 22b, respectively.

The first and second amplifiers 26a and 26b may amplify data signals output from the primary integrators 21a and 21b and provide amplified data signals to the secondary integrators 22a and 22b, respectively. Therefore, a potential difference between the data signals output from the primary integrators 21a and 21b may be amplified before the data signals are input to the first and second secondary integrators 22a and 22b, respectively.

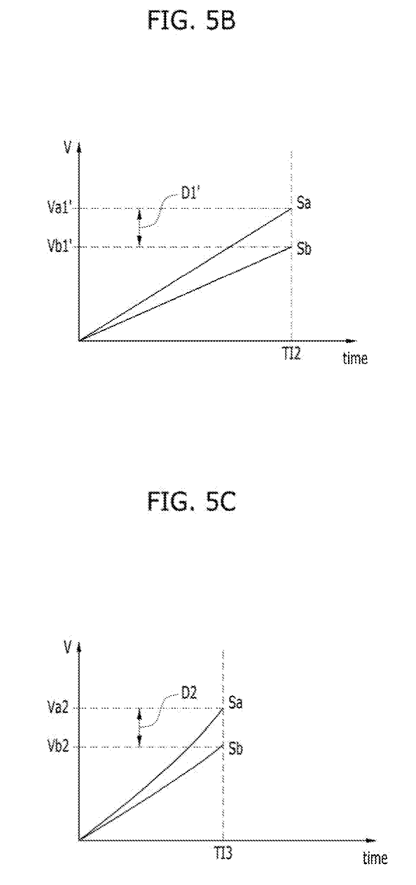

FIGS. 5A to 5C are graphs showing a process of reading a first data pattern in the neuromorphic device of FIG. 4 in accordance with the embodiment. Referring to FIGS. 4 and 3A, in a reading mode, when a first data read signal is input from the pre-synaptic neuron 10 to the first and second synapses 30a and 30b through the row line R in order to read the first data pattern that has been learned by the first synapse 30a, the first data signal Sa and the second data signal Sb may be output from the first and second synapses 30a and 30b to the respective input terminals of the first and second post-synaptic neurons 20a and 20b, e.g., the input terminals of the first and second primary integrators 21a and 21b connected to a first node A0 and a second node B0, respectively.

Referring to FIGS. 4 and 5A, a voltage level Va1 of the first data signal Sa that was measured at a third node A1 after passing through the first primary integrator 21a and a voltage level Vb1 of the second data signal Sb that was measured at a fourth node B1 after passing through the second primary integrator 21b may be increased to from zero volt, respectively. As a result, at the end of a time interval TI1, a difference between the voltage level Va1 at the third node A1 and the voltage level Vb1 at the fourth node B1 increases to a first potential difference D1.

Referring to FIGS. 4 and 5B, a voltage level Va1′ of the first data signal Sa that was measured at a fifth node A1′ after passing through the first amplifier 26a and a voltage level Vb1′ of the second data signal Sb that was measured at a sixth node B1′ after passing through the second amplifier 26b may be increased from zero volt, respectively. As a result, at the end of a time interval TI2, a difference between the voltage level Va1′ at the fifth node A1′ and the voltage level Vb1′ at the sixth node B1 increases to an amplified potential difference D1′.

Referring to FIGS. 4 and 5C, a voltage level Va2 of the first data signal Sa that was measured at a seventh node A2 after passing through the first secondary integrator 22a and a voltage level Vb2 of the second data signal Sb that was measured at an eighth node B2 after passing through the second secondary integrator 22b may be exponentially increased from zero volt, respectively. As a result, at the end of a time interval TI3, a difference between the voltage level Va2 at the seventh node A2 and the voltage level Vb2 at the eighth node B2 increases to a second potential difference D2. Assuming that the voltage level Va2 of the first data signal Sa at the seventh node A2 becomes the same as or higher than a level of the reference voltage Vr before the voltage level Vb2 of the second data signal Sb at the eighth node B2 becomes as such, the first comparator 25a of the first post-synaptic neuron 20a may output an electrical signal earlier than the second comparator 25b of the second post-synaptic neuron 20b does. When the first post-synaptic neuron 20a is fired first, the second post-synaptic neuron 20b may be disabled. Consequently, an occurrence of a data recognition error may be reduced in accordance with the embodiment of the present disclosure.

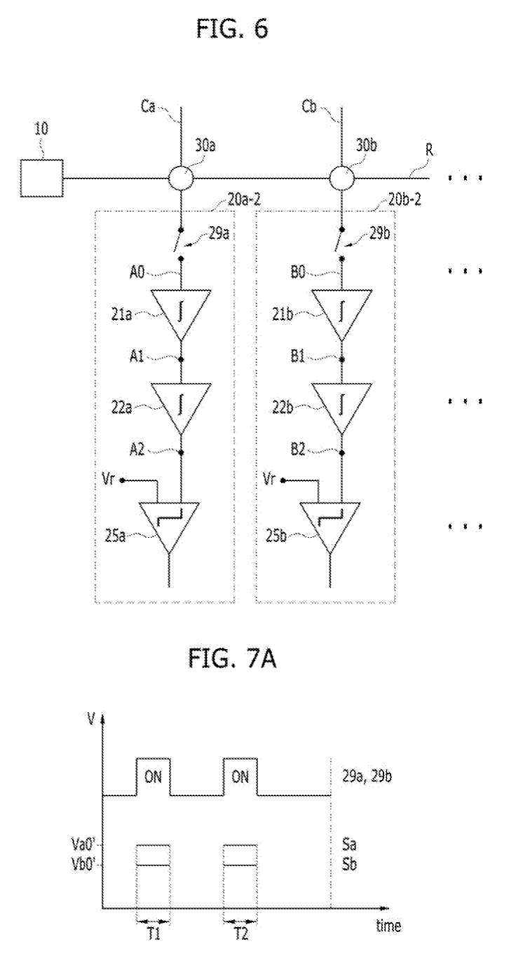

FIG. 6 is a block diagram conceptually illustrating a portion of a neuromorphic device, particularly, first and second post-synaptic neurons 20a-2 and 20b-2, in accordance with an embodiment of the present disclosure. Referring to FIG. 6, the first and second post-synaptic neurons 20a and 20b may include first and second sampling elements 29a and 29b that are disposed between the input terminals of the first and second primary integrators 21a and 21b and the first and second synapses 30a and 30b, in addition to the constituent elements of the first and second post-synaptic neurons 20a and 20b illustrated in FIG. 2. The first and second sampling elements 29a and 29b may be switching elements, e.g., MOS transistors.

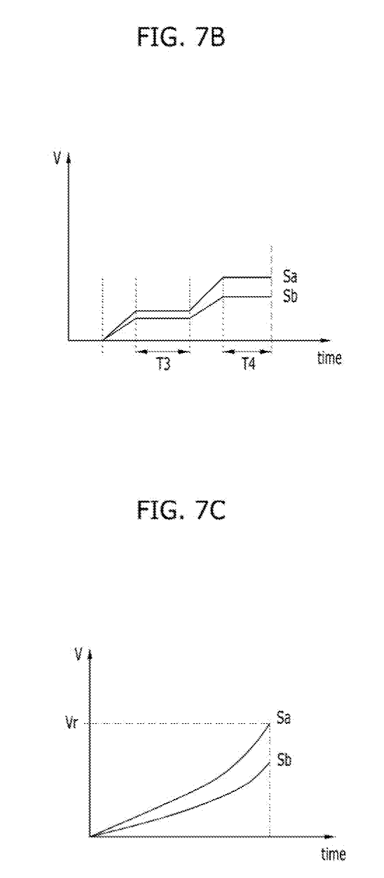

FIGS. 7A to 7C are graphs showing a process of reading a first data pattern in the neuromorphic device in accordance with the embodiment shown in FIG. 6. Referring to FIG. 6, in a reading mode, when the first data read signal is input from the pre-synaptic neuron 10 to the first and second synapses 30a and 30b through the row line R in order to read the first data pattern that has been learned by the first synapse 30a, the first data signal Sa and the second data signal Sb may be output from the first and second synapses 30a and 30b to respective input terminals of the first and second post-synaptic neurons 20a-2 and 20b-2, e.g., input terminals of the first and second sampling elements 29a and 29b.

Referring to FIGS. 6 and 7A, the first data signal Sa and the second data signal Sb output from the first and second synapses 30a and 30b may be sampled by the first and second sampling elements 29a and 29b according to a switching control signal, respectively. Thus, a voltage level Va0′ of the first data signal Sa that was measured at a first node A0 after passing through the first sampling element 29a and a voltage level Vb0′ of the second data signal Sb that was measured at a second node B0 after passing through the second sampling element 29b may exist intermittently. In other words, the first data signal Sa and the second data signal Sb may be transmitted to the first node A0 and the second node B0 only when the first and second sampling elements 29a and 29b are turned on, e.g., during a first time interval T1 and a second time interval T2.

Referring to FIGS. 6 and 7B, a voltage level of the first data signal Sa that was measured at a third node A1 after passing through the first primary integrator 21a and a voltage level of the second data signal Sb that was measured at a fourth node B1 after passing through the second primary integrator 21b may be increased when the first and second sampling elements 29a and 29b are turned on, i.e., during the first and second time intervals T1 and T2. Specifically, during the first and second time intervals T1 and T2, a voltage level of the first data signal Sa that was measured at the third node A1 and a voltage level of the second data signal Sb that was measured at the fourth node B1 increase substantially linearly. During third and fourth time intervals T3 and T4 when the first and second sampling elements 29a and 29b are turned off, the voltage level of the first data signal Sa that was measured at the third node A1 and the voltage level of the second data signal Sb that was measured at the fourth node B1 remain substantially the same. In other words, when the first and second sampling elements 29a and 29b are turned on repeatedly, a voltage difference between the first data signal Sa at the third node A1 and the second data signal Sb at the fourth node B1 may become greater.

Referring to FIGS. 6 and 7C, a voltage level of the first data signal Sa that was measured at a fifth node A2 after passing through the first secondary integrator 22a and a voltage level of the second data signal Sb that was measured at a sixth node B2 after passing through the second secondary integrator 22b may be increased. Thus, a voltage difference between the first data signal Sa at the fifth node A2 and the second data signal Sb at the sixth node B2 may be non-linearly increased. Specifically, during the first and second time intervals T1 and T2 when the first and second sampling elements 29a and 29b are turned on, the voltage level of the first data signal Sa that was measured at the fifth node A2 and the voltage level of the second data signal Sb that was measured at the sixth node B2 increase substantially quadratically. During the third and fourth time intervals T3 and T4 when the first and second sampling elements 29a and 29b are turned off, the voltage level of the first data signal Sa that was measured at the fifth node A2 and the voltage level of the second data signal Sb that was measured at the sixth node B2 increase substantially linearly. Assuming that the voltage level of the first data signal Sa that was measured at the fifth node A2 becomes the same as or higher than a level of the reference voltage Vr before the voltage level of the second data signal Sb that was measured at the sixth node B2 becomes as such, the first comparator 25a of the first post-synaptic neuron 20a may output an electrical signal earlier than the second comparator 25b of the second post-synaptic neuron 20b does. When the first post-synaptic neuron 20a is fired, the second post-synaptic neuron 20b may be disabled. Consequently, an occurrence of a data recognition error may be reduced in accordance with the embodiment of the present disclosure.

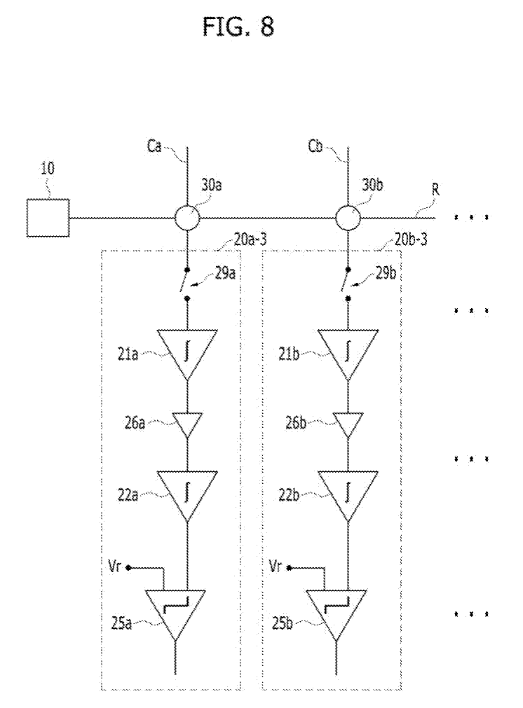

FIGS. 8 to 11 are block diagrams conceptually illustrating portions of neuromorphic devices in accordance with various embodiments of the present disclosure.

Referring to FIG. 8, a neuromorphic device in accordance with an embodiment of the present disclosure may include first and second post-synaptic neurons 20a-3 and 20b-3. The first and second post-synaptic neurons 20a-3 and 20b-3 include first and second amplifiers 26a and 26b that are disposed between the first and second primary integrators 21a and 21b and the first and second secondary integrators 22a and 22b, respectively, in addition to the constituent elements of the first and second post-synaptic neurons 20a-2 and 20b-2 illustrated in FIG. 6. The neuromorphic device of FIG. 8, which further includes the first and second amplifiers 26a and 26b, may be understood by referring to FIGS. 4, 6, 7B, and 7C. Since the first and second amplifiers 26a and 26b of FIG. 8 are capable of amplifying the voltage level of the first data signal Sa at the third node A1 and the voltage level of the second data signal Sb at the fourth node B1, referring to FIGS. 6 and 7B, the voltage difference between the first data signal Sa and the second data signal Sb may become greater. Therefore, the voltage difference between the first data signal Sa and the second data signal Sb after passing through the first and second secondary integrators 22a and 22b may become greater than the difference between the voltage level of the first data signal Sa at the fifth node A2 and the voltage level of the second data signal Sb at the sixth node B2 shown in FIG. 7C. As a result, the first comparator 25a of the post-synaptic neurons 20a-3 may output the data signal more quickly than the first comparator 25a of the post-synaptic neurons 20a-2 shown in FIG. 6. In short, the first post-synaptic neuron 20a-3 may be fired much earlier than the second post-synaptic neuron 20b-3.

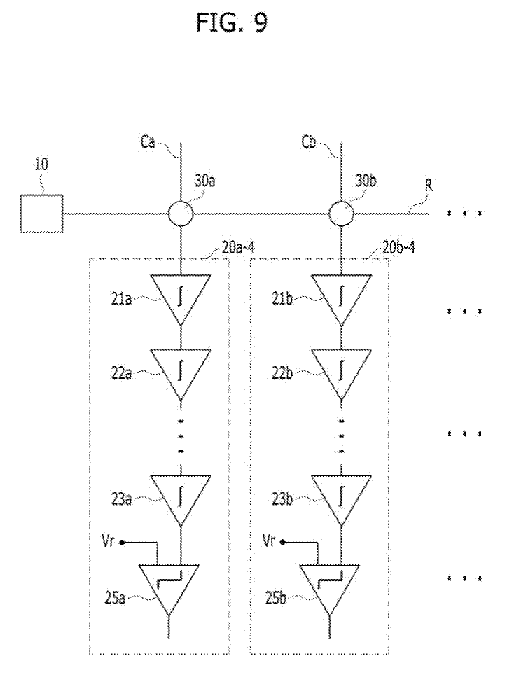

Referring to FIG. 9, first and second post-synaptic neurons 20a-4 and 20b-4 of a neuromorphic device in accordance with another embodiment of the present disclosure may include a plurality of integrators 21a, 21b, 22a, 22b, 23a, and 23b, such that each of the first and second post-synaptic neurons 20a-4 and 20b-4 includes more than three integrators. Consequently, a difference between a voltage level of the first data signal Sa and a voltage level of the second data signal Sb at respective nodes connected to first and second comparators 25a and 25b may become greater than a difference between voltage levels at corresponding nodes (e.g., the fifth and sixth nodes A2 and B2 of the embodiment shown in FIG. 2) connected to respective comparators (e.g., the first and second comparators 25a and 25b of the embodiment shown in FIG. 2) of the above-described embodiments.

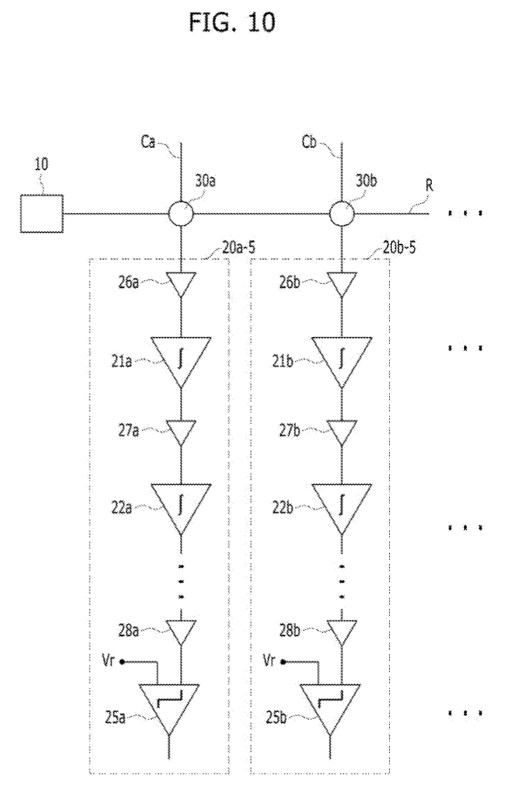

Referring to FIG. 10, first and second post-synaptic neurons 20a-5 and 20b-5 of a neuromorphic device in accordance with yet another embodiment of the present disclosure may include first and second comparators 25a and 25b, a plurality of integrators, e.g., 21a, 21b, 22a, and 22b, such that each of the first and second post-synaptic neurons 20a-5 and 20b-5 includes more than two integrators, and a plurality of amplifiers, e.g., 26a, 26b, 27a, 27b, 28a, and 28b that are electrically connected to input terminals of the plurality of integrators and input terminals of the first and second comparators 25a and 25b. For example, the first and second post-synaptic neurons 20a-5 and 20b-5 may include the primary amplifiers 26a and 26b that are respectively disposed between the first and second synapses 30a and 30b and the first and second primary integrators 21a and 21b, the secondary amplifiers 27a and 27b that are respectively disposed between the first and second primary integrators 21a and 21b and the first and second secondary integrators 22a and 22b, and the final amplifiers 28a and 28b that are respectively disposed ahead of the input terminals of the first and second comparators 25a and 25b. Due to the presence of the plurality of amplifiers 26a, 26b, 27a, 27b, 28a, and 28b, a difference between a voltage level of the first data signal Sa and a voltage level of the second data signal Sb at respective nodes connected to the first and second comparators 25a and 25b may become greater than a difference between voltage levels at corresponding nodes (e.g., the fifth and sixth nodes A2 and B2 of the embodiment shown in FIG. 2) connected to respective comparators (e.g., the first and second comparators 25a and 25b in the embodiment shown in FIG. 2) of the above-described embodiments.

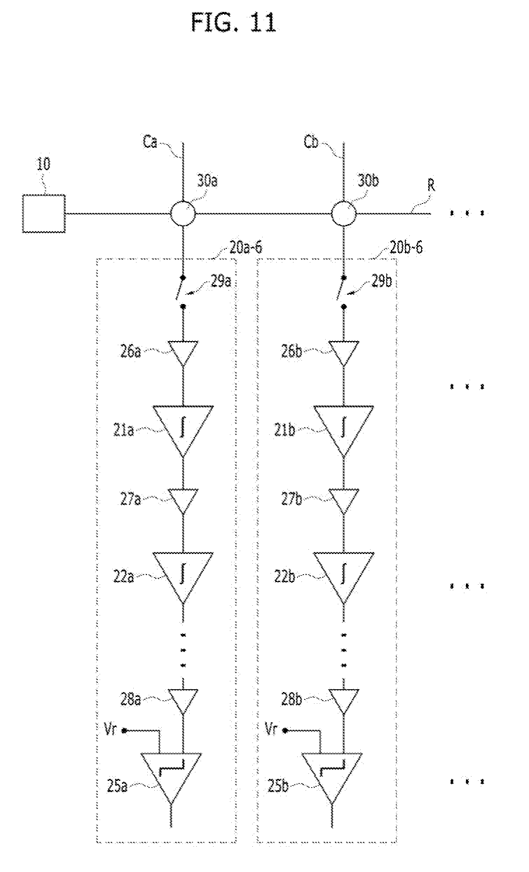

Referring to FIG. 11, first and second post-synaptic neurons 20a-6 and 20b-6 of a neuromorphic device in accordance with still another embodiment of the present disclosure may include first and second sampling elements 29a and 29b in addition to the constituent elements of the first and second post-synaptic neurons 20a-5 and 20b-5 illustrated in FIG. 10. Due to the presence of the plurality of amplifiers 26a, 26, 27a, 27b, 28a, and 28b, a difference between a voltage level of the first data signal Sa and a voltage level of the second data signal Sb at respective nodes connected to first and second comparators 25a and 25b may become greater than a difference between voltage levels at corresponding nodes (e.g., the fifth and sixth nodes A2 and B2 of the embodiment shown in FIG. 6) connected to respective comparators (e.g., the first and second comparators 25a and 25b the embodiment shown in FIG. 6) of the above-described embodiments.

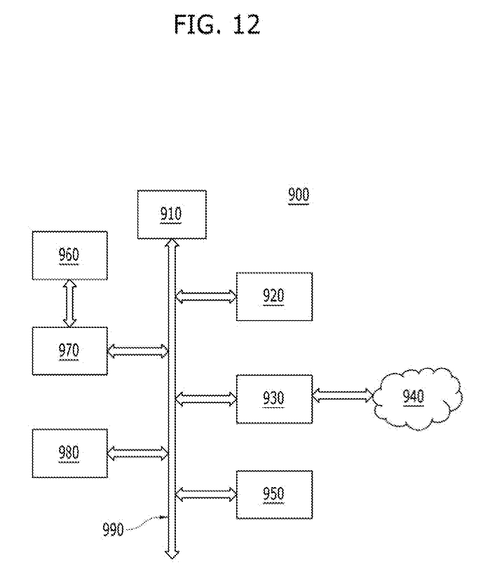

FIG. 12 is a block diagram conceptually illustrating a pattern recognition system 900 in accordance with an embodiment of the present disclosure. For example, the pattern recognition system 900 may be one selected from a group including a speech recognition system, an image recognition system, a code recognition system, a signal recognition system, and any of other diverse systems for recognizing diverse patterns.

Referring to FIG. 12, the pattern recognition system 900 in accordance with the embodiment of the present disclosure may include a central processing unit 910, a memory unit 920, a communication control unit 930, a network 940, an output unit 950, an input unit 960, an analog-to-digital converting unit 970, a neuromorphic unit 980, and a bus 990.

The central processing unit 910 may generate and transfer diverse signals for a learning process by the neuromorphic unit 980, and perform diverse operations and functions to recognize speech and image patterns based on an output of the neuromorphic unit 980. The central processing unit 910 may be connected to the memory unit 920, the communication control unit 930, the output unit 950, the analog-to-digital converting unit 970, and the neuromorphic unit 980 through the bus 990.

The memory unit 920 may store diverse data in accordance with operations of the pattern recognition system 900. The memory unit 920 may include at least one selected from a group including a volatile memory device, such as a Dynamic Random Access Memory (DRAM) or a Static Random Access Memory (SRAM), a non-volatile memory device, such as a Phase-Change Random Access Memory (PRAM), a Magnetic Random Access Memory (MRAM), a Resistive Random Access Memory (ReRAM), and a NAND flash memory, a memory unit, such as a hard disk drive (HDD) and a Solid State Drive (SSD), and the like.

The communication control unit 930 may transfer and/or receive recognized data, such as speech and image, to and/or from a communication control unit of another system through the network 940.

The output unit 950 may output the recognized data, such as speech and image, using diverse methods. For example, the output unit 950 may include at least one selected from a group including a speaker, a printer, a monitor, a display panel, a beam projector, a hologrammer, and so on.

The input unit 960 may include at least one selected from a group including a microphone, a camera, a scanner, a touch pad, a key board, a mouse, a mouse pen, a sensor, and so on.

The analog-to-digital converting unit 970 may convert analog data transmitted from the input unit 960 into digital data.

The neuromorphic unit 980 may perform such functions as learning and recognition based on the data transmitted from the analog-to-digital converting unit 970, and output data corresponding to a recognized pattern. The neuromorphic unit 980 may include at least one among the neuromorphic devices in accordance with the diverse embodiments of the present disclosure.

According to the embodiments of the present disclosure, since a voltage difference between similar data signals is amplified to be sufficiently great, it is possible to substantially prevent or remarkably decrease an occurrence of data recognition errors.

Other beneficial effects of the embodiments of the present disclosure are described in the detailed description of the present patent specification.

While the inventive concepts has been described with respect to the specific embodiments, it will be apparent to those skilled in the art that various changes and modifications may be made without departing from the spirit and scope of the invention as defined in the following claims.

What is claimed is:

1. A neuromorphic device comprising:
a pre-synaptic neuron;
a row line electrically coupled to the pre-synaptic neuron;
a post-synaptic neuron;
a column line electrically coupled to the post-synaptic neuron; and
a synapse disposed at a cross point between the row line and the column line,
wherein the post-synaptic neuron includes:
a first integrator electrically coupled to the synapse;
a second integrator electrically coupled to the first integrator; and
a comparator electrically coupled to the second integrator.

2. The neuromorphic device of claim 1, wherein the synapse and an input terminal of the first integrator are electrically connected to each other.

3. The neuromorphic device of claim 1, wherein an output terminal of the first integrator and an input terminal of the second integrator are electrically connected to each other.

4. The neuromorphic device of claim 1, wherein an output terminal of the second integrator and an input terminal of the comparator are electrically connected to each other.

5. The neuromorphic device of claim 1, wherein the synapse, the first integrator, the second integrator, and the comparator are electrically connected in series.

6. The neuromorphic device of claim 1, wherein the post-synaptic neuron further includes:
a first amplifier disposed between an output terminal of the first integrator and an input terminal of the second integrator.

7. The neuromorphic device of claim 6, wherein the post-synaptic neuron further includes:
a second amplifier disposed between an output terminal of the second integrator and an input terminal of the comparator.

8. The neuromorphic device of claim 1, wherein the post-synaptic neuron further includes:
a sampling element disposed between the synapse and the first integrator.

9. The neuromorphic device of claim 8, wherein the sampling element includes a switching element.

10. The neuromorphic device of claim 8, wherein the post-synaptic neuron further includes:
an amplifier disposed between the sampling element and the first integrator.

11. The neuromorphic device of claim 1, wherein the first integrator and the second integrator are leaky integrators.

12. The neuromorphic device of claim 1, wherein the post-synaptic neuron is a first post-synaptic neuron, the synapse is a first synapse, and the comparator is a first comparator, the device further comprising a second post-synaptic neuron coupled to a second synapse, the first synapse and the second synapse being coupled to the row line,
wherein the first post-synaptic neuron further includes:
a third integrator serially connected between the second integrator and the first comparator, and
wherein the second post-synaptic neuron includes:
a fourth integrator electrically connected to the second synapse;
a fifth integrator electrically connected to the fourth integrator;
a sixth integrator electrically connected to the fifth integrator; and
a second comparator electrically connected to the sixth integrator.

13. A neuromorphic device, comprising:
a pre-synaptic neuron;
a synapse electrically coupled to the pre-synaptic neuron; and
a post-synaptic neuron electrically coupled to the synapse,
wherein the post-synaptic neuron includes:
at least two integrators coupled in series to each other; and
a comparator coupled to the at least two integrators.

14. The neuromorphic device of claim 13, wherein the post-synaptic neuron further includes:
one or more amplifiers each disposed between two adjacent integrators among the at least two integrators.

15. The neuromorphic device of claim 13, wherein the post-synaptic neuron further includes:
an amplifier disposed between a last one of the at least two integrators and the comparator, the last one of the at least two integrators being a farthest integrator from the synapse.

16. The neuromorphic device of claim 13, wherein the post-synaptic neuron further includes:
an amplifier disposed between the synapse and a first one of the at least two integrators, the first one of the at least two integrators being a closest integrator to the synapse.

17. The neuromorphic device of claim 13, wherein the post-synaptic neuron further includes:
a sampling element disposed between the synapse and a first one of the at least two integrators, the first one of the at least two integrators being a closest integrator to the synapse.

18. A neuromorphic device, comprising:
a pre-synaptic neuron;
a synapse electrically coupled to the pre-synaptic neuron, the synapse generating a data signal according to a data pattern in a reading mode; and
a post-synaptic neuron electrically coupled to the synapse,
wherein the post-synaptic neuron includes:
a first integrator coupled to the synapse, the first integrator performing a first integration operation on the data signal to generate a first integrated version of the data signal;
a second integrator coupled to the first integrator, the second integrator performing a second integration operation on the first integrated version of the data signal to generate a second integrated version of the data signal; and
a comparator coupled to the second integrator, the comparator comparing the second integrated version of the data signal to a reference signal.

19. The neuromorphic device of claim 18, wherein the post-synaptic neuron further includes an amplifier disposed between the first integrator and the second integrator, the amplifier amplifying the first integrated version of the data signal and outputting the amplified signal to the second integrator.

20. The neuromorphic device of claim 18, wherein the post-synaptic neuron further includes a switching element disposed between the synapse and the first integrator, the switching element coupling the synapse and the first integrator in response to a switching control signal.
